(19) United States
(12) Patent Application Publication
(10) Pub. No.: US 2004/0012535 A1
(43) Pub. Date: Jan. 22, 2004

(54) Titanium antenna

(76) Inventor: Michael J. Stone, Boardman, OH (US)

Correspondence Address: SAND & SEBOLT, AEGIS TOWER, SUITE 1100, 4940 MUNSON STREET, NW, CANTON, OH, 44718-3615, US

(21) Appl. No.: 10/423,811

(22) Filed: Apr. 24, 2003

Related U.S. Application Data
(60) Provisional application No. 60/375,731, filed on Apr. 26, 2002.

(51) Int. Cl. H01Q 19/10; H01Q 21/00

(52) U.S. Cl. 343/818; 343/817

(57) ABSTRACT

An antenna for radiating and receiving electromagnetic radiation constructed substantially of Titanium, and in particular Grade 2 or Grade 4 Titanium.

### CROSS REFERENCE TO RELATED APPLICATION

This application is a standard utility of provisional patent application serial No. 60/375,731, filed Apr. 26, 2002, the contents of which are incorporated herein.

### BACKGROUND OF THE INVENTION

1. Technical Field

The present invention relates to communications and more particularly to radio wave antennas, and still more particularly to materials for use in constructing radio wave antennas.

2. Background Information

Many antennas are constructed of aluminum. The use of aluminum results in a number of problems including some corrosion, stress related failure and the need for secondary support to help maintain design shape in many antennas. Aluminum antennas' performance typically degrade overtime due to galvanic corrosion, both on the surface and at the mechanical/electrical connections of the antenna. Typical aluminum antennas are formed of aluminum which has an ultimate tensile strength of between 15.9 ksi and 37.8 ksi for T4 and T6 temper. Although these types of aluminum which are commonly used for aluminum antennas, provide some structural strength and rigidity, they usually require secondary bracing for larger antennas which increases the cost and required area for the antenna installation.

A number of antennas have been designed which use a titanium alloy, usually nickel-titanium alloy for various components of an antenna. These are used principally for strength and not for the transmission feature or capability of the antenna. Some examples of antennas using a titanium alloy are shown in U.S. Pat. Nos. 6,061,036, 5,220,338, 4,388,623, and 6,046,708. However, none of these disclose the use of titanium, and in particular, a Grade 2 or Grade 4 Titanium for forming the majority of the antenna and not just portions thereof as shown in these earlier patents.

### BRIEF SUMMARY OF THE INVENTION

It is an object of the present invention to provide an antenna which has superior corrosion and increase strength than aluminum antennas, and which has improved radiation and reception characteristics.

Another feature of the invention is to form the antenna principally of Grade 2 Titanium as the preferred material, or a Grade 4 Titanium as a possible substitution therefor.

Still another aspect of the invention is to be able to provide larger antennas with less support then prior art aluminum antennas by the use of titanium for forming the main components of the antenna, which in addition to providing increased strength and support, provides transmission and reception capabilities which are at least equal to or greater than that provided by aluminum antennas.

Another feature of the invention is to form helical antennas as well as YAGI type antennas out of titanium, and in particular, Grade 2 or Grade 4 Titanium, to provide for the increased strength and increased transmission and reception capabilities.

These and other objects are met by the present invention which is an antenna for radiating and receiving electromagnetic radiation which is constructed in substantial part of a metal selected from the group consisting of titanium, and in particular Grade 2 or Grade 4 Titanium.

### BRIEF DESCRIPTION OF THE DRAWINGS

Preferred embodiments of the invention, illustrative of the best modes in which applicant contemplates applying the principles, are set forth in the following description and are shown in the drawings and are particularly and distinctly pointed out and set forth in the appended claims.

FIG. 1 is a side elevational view of an antenna representing a preferred embodiment of the present invention;

FIG. 2 is a plan view of the antenna shown in FIG. 1;

FIG. 3 is a side elevation view representing another embodiment of the antenna of the present invention;

FIG. 4 is a graph showing a comparison of standard wave ratios between a titanium and a conventional aluminum antenna;

FIG. 5 is a graph showing an impedance comparison between a titanium and a conventional aluminum antenna;

FIG. 6 is a graph showing a resistance comparison between a titanium and a conventional aluminum antenna;

FIG. 7 is a graph showing a reactance comparison between a titanium and a conventional aluminum antenna;

FIG. 8 is a graph showing a capacitance comparison between a titanium and a conventional aluminum antenna;

FIG. 9 is a graph showing an inductance comparison between a titanium and a conventional aluminum antenna; and

FIGS. 10-16A are azimuth cuts at various frequencies comparing the titanum antenna of the present invention with a conventional aluminum antenna.

### DETAILED DESCRIPTION OF THE PREFERRED EMBODIMENTS

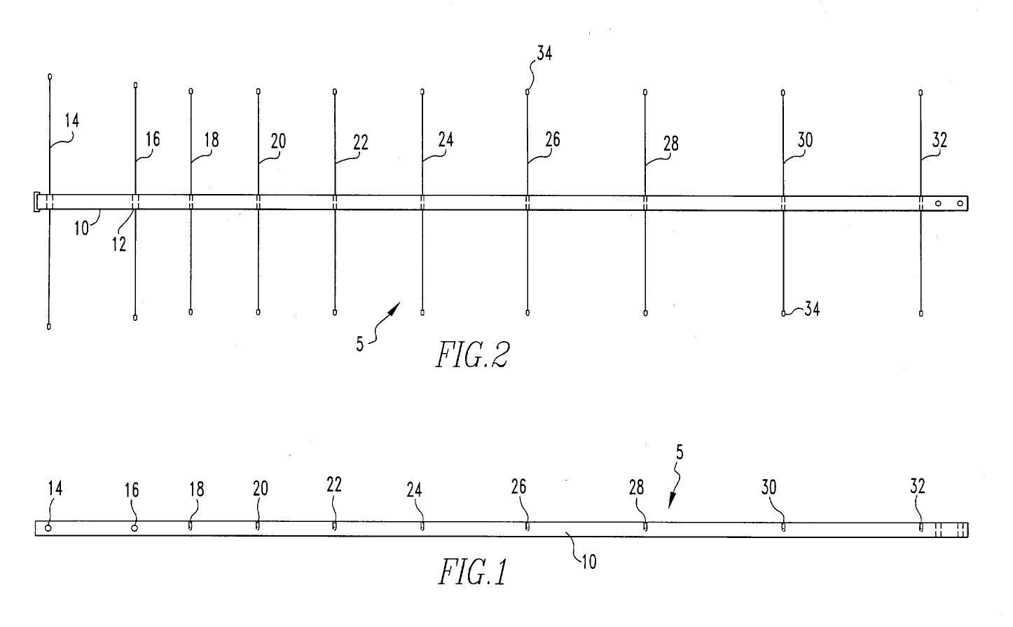

FIGS. 1 and 2 show a preferred type of antenna indicated generally at 5, which is a YAGI type. Antenna 5 has a boom 10 with a zero reference point 12 through which extends a driver element 16. A reflector element 14 is mounted at one end of boom 10 and extends in a generally horizontal direction perpendicular to boom 10. A number of other elements, which are insulated dipoles, are arranged in a parallel relationship to each other and to reflector element 14 and are indicated at 18, 20, 22, 24, 26, 28, 30, and 32. These elements lie in the same plane as reflector element 14 and driver element 16 as shown in FIGS. 1 and 2. At each end of the elements there is a plastic cap 34 mounted thereon.

In accordance with the main feature of the invention, each of the elements and the boom described above is comprised of titanium, and in particular, Grade 2 or Grade 4 Titanium. The lengths and diameters of the elements in the preferred embodiment are shown in Table 1 incorporated herein.

Grade 2 Titanium (ATM B 338) is the preferred titanium for constructing the antenna which provides the desired strength and rigidity and the improved reception and transmission. This material has a tensile strength of 50 ksi minimum, and a yield strength of between 40 ksi and 65 ksi at 20% elongation and preferably is configured in tubular form as shown in Table 1.

Another type of titanium also found suitable is Grade 4 which has a tensile strength of 80 ksi minimum, and a yield strength of between 70 ksi and 95 ksi at 15% elongation. Whereas T6061 (Alcoa® code number) aluminum, which is used for many antennas, has an ultimate tensile strength of 26 ksi for T4 temper and 39 ksi for the T6 temper, and a yield strength of 15.9 ksi for the T4 temper and 37.8 ksi for the T6 temper. T6063 (Alcoa® code number) aluminum, which is also used for many antennas, has an ultimate tensile strength of between 19 ksi and 29 ksi and a yield tensile strength of between 10 ksi and 25 ksi depending on temper. Thus in comparison, Grade 4 Titanium is roughly 2-3 times stronger than the usual aluminum antennas. Furthermore, electrical resistance and conductivity differ significantly between aluminum and titanium. The resistance of the T6061 type aluminum is 32.5 and its N Ω*m whereas Grade 4 Titanium has a resistance of 600 N Ω*M.

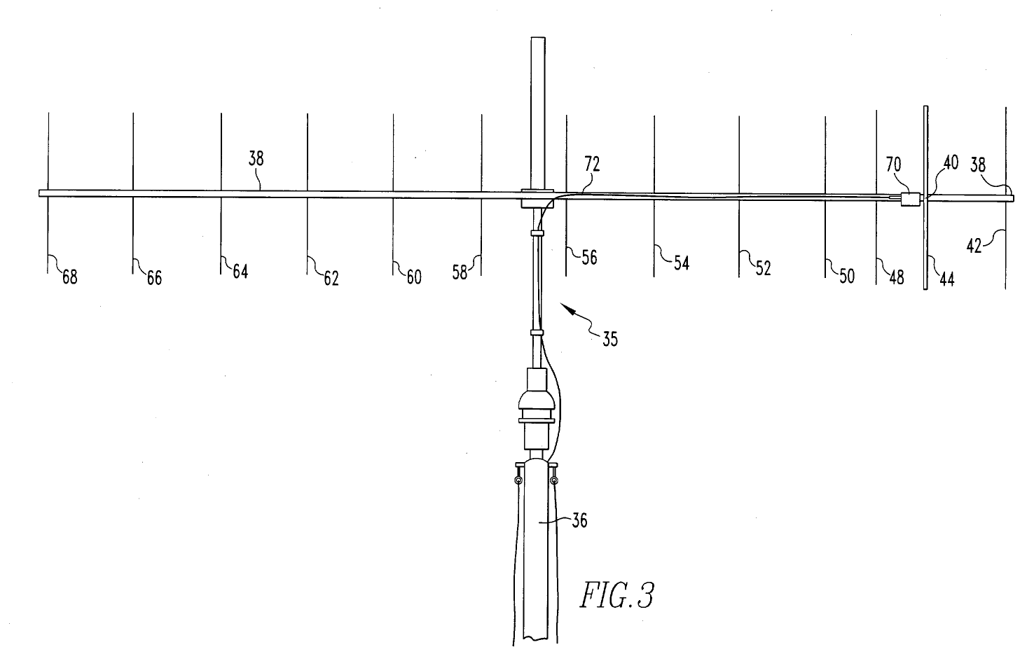

Another embodiment of the antenna of the present invention is shown in FIG. 3 and is indicated generally at 35. Antenna 35 is mounted on a central support 36 and has a boom 38. There is a zero reference point at 40 through which a driver element 44 extends which is parallel with reflector element 42. A plurality of director elements or insulated dipoles indicated at 48, 50, 52, 54, 56, 58, 60, 62, 64, 66, and 68, are mounted on and extend transversely from boom 38 in a spaced parallel relationship and in the same plane as boom 38 and elements 42 and 44. A cable 72 is attached to zero reference point 40 and is connected to the electronics of the radio transmitter/receiver (not shown). The lengths and diameters of the elements of antenna 35 are shown in Table 2. As in accordance with the invention, antenna 35 is made of the same grades of titanium as described above for antenna 5.

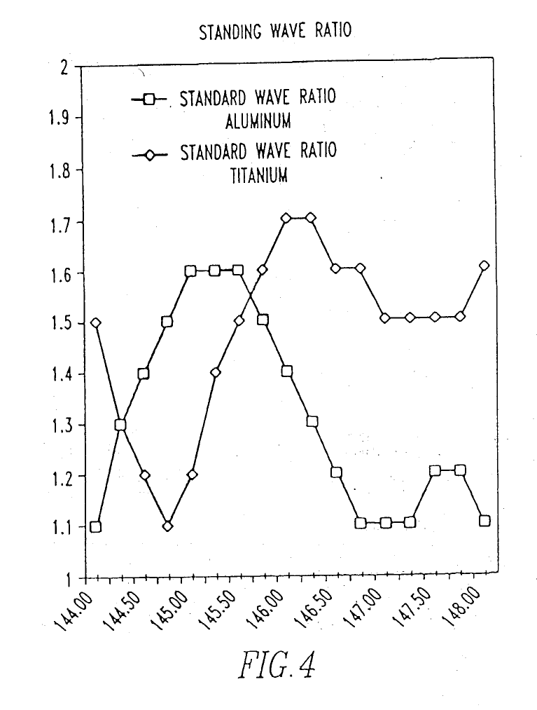

A YAGI antenna (not shown) essentially identical to that of antenna 35 which was constructed almost entirely of Grade 2 Titanium, was made of an aluminum alloy namely, such as T6061 per Alcoa® code. This aluminum has an ultimate tensile strength of 26 ksi for T4 temper and 37.7 ksi for T6 temper and a yield strength of between 15.9 ksi and 34.7 ksi. These two antennas (Titanium and Aluminum) which were thirteen elements, 2 meter antennas, were tested and compared. The standing wave ratio (SWR) which is a measurement derived as ratio of the fore power versus reflective power and which is used to determine exactly where in the radio spectrum an antenna is resident, and which is an excellent indicator of how broad banded a radio is, was measured for the two antennas in frequencies between 144-148 Mhz. The results of these standing wave measurements are shown in Table 3 and FIG. 4.

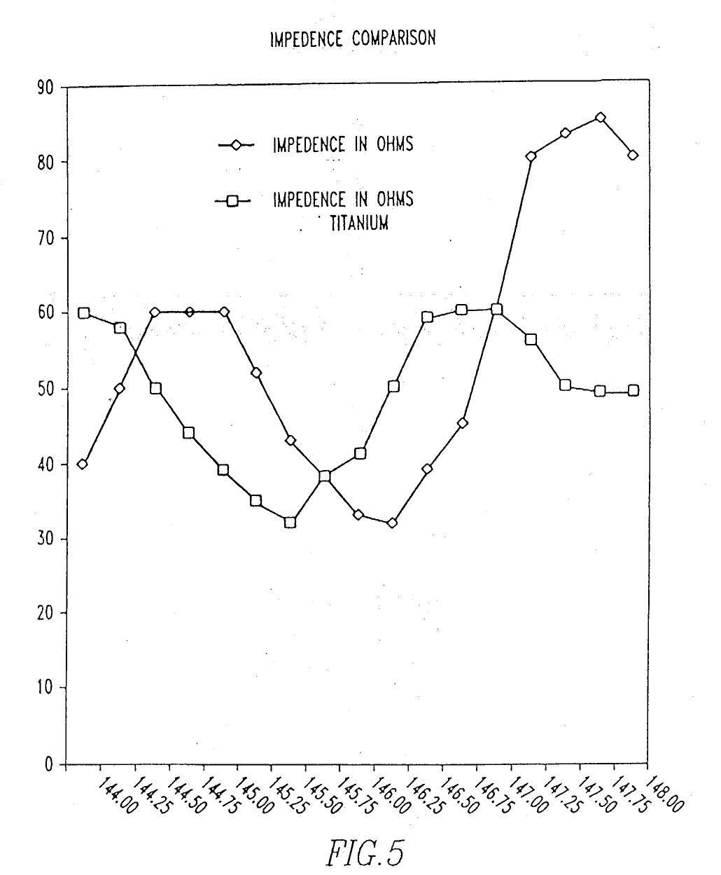

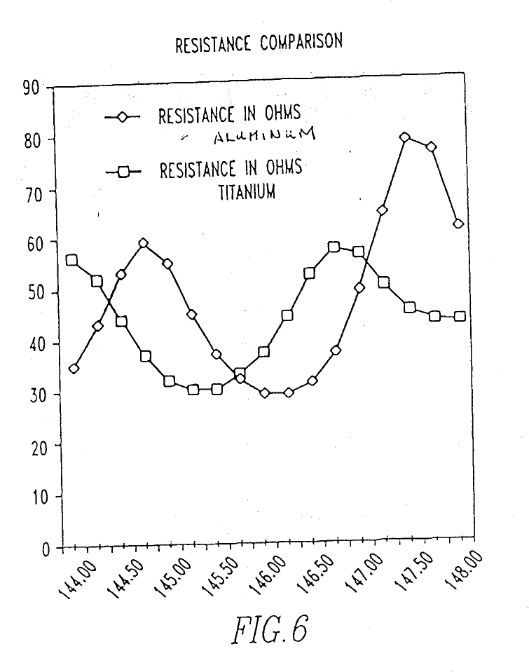

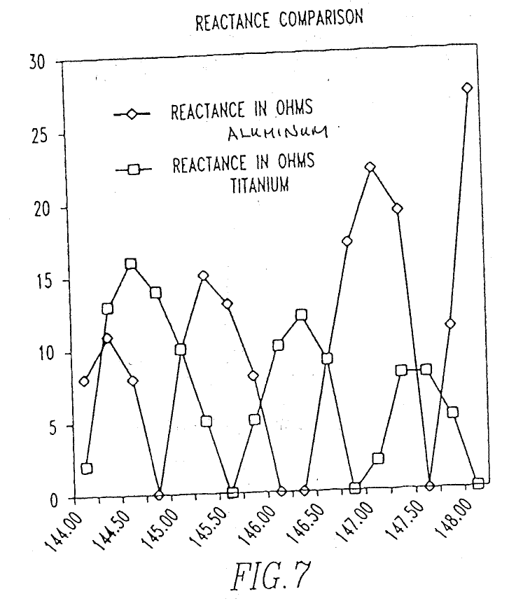

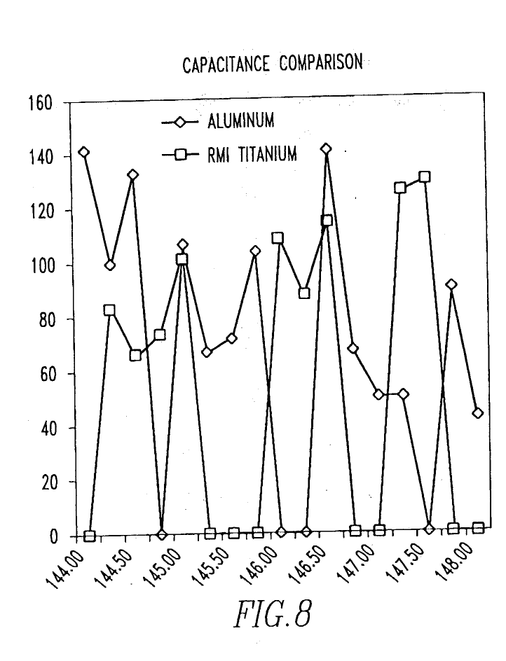

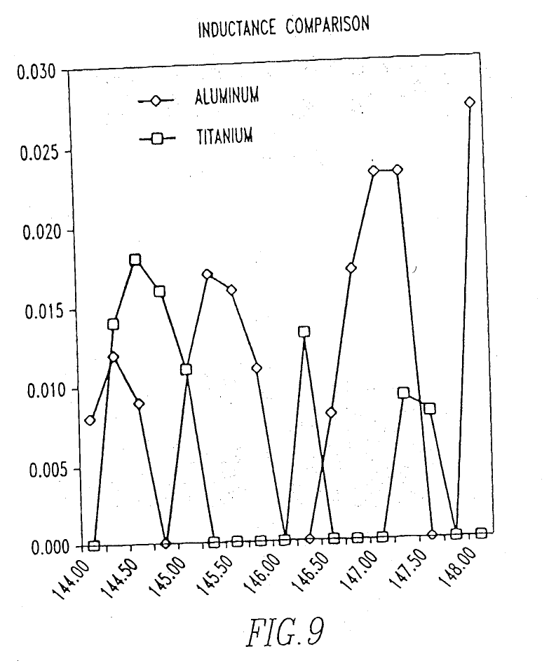

Impedance of these two test antennas was also measured in the frequency range of 144-148 Mhz and results of these measurements shown in Table 4 and FIG. 5. Resistance was also measured for these two antennas in the frequency range of 144-148 Mhz and these measurements are shown in Table 5 and FIG. 6. Reactance was compared in the frequency range of 144-148 Mhz and the results of these measurements are shown in Table 6 and FIG. 7. Capacitance was also measured and the results are shown in Table 7 and FIG. 8. Inductance was compared in the frequency range 144-148 Mhz and results of these comparisons are shown in Table 8 and FIG. 9.

Tables 9 and 10 show the impedance breakdown of resistance and reactive for the standing wave ratio tests performed on the two test antennas. These tests show that the antenna constructed almost entirely of Grade 2 titanium is superior to the Aluminum antenna.

Another comparison test was also made to measure and record the radiation patterns of two 70 Cm, 10 element YAGI antennas, similar to that shown in FIG. 1 and described above, one of which was made of Grade 2 Titanium and the other of a T6061 (Alcoa® code number) aluminum alloy. The radiation pattern range was 110 feet long and the antennas were located at the top of a tower 30 feet from the ground. The antennas were peaked for maximum signal by adjusting the azimuth and elevation axises. The radiation pattern was recorded on 360° polar plots for the frequencies of 420, 435 and 450 MHz for both horizontal and vertical polarizations. A dielectric rod was used to fasten the antennas to the tower to reduce reflections.

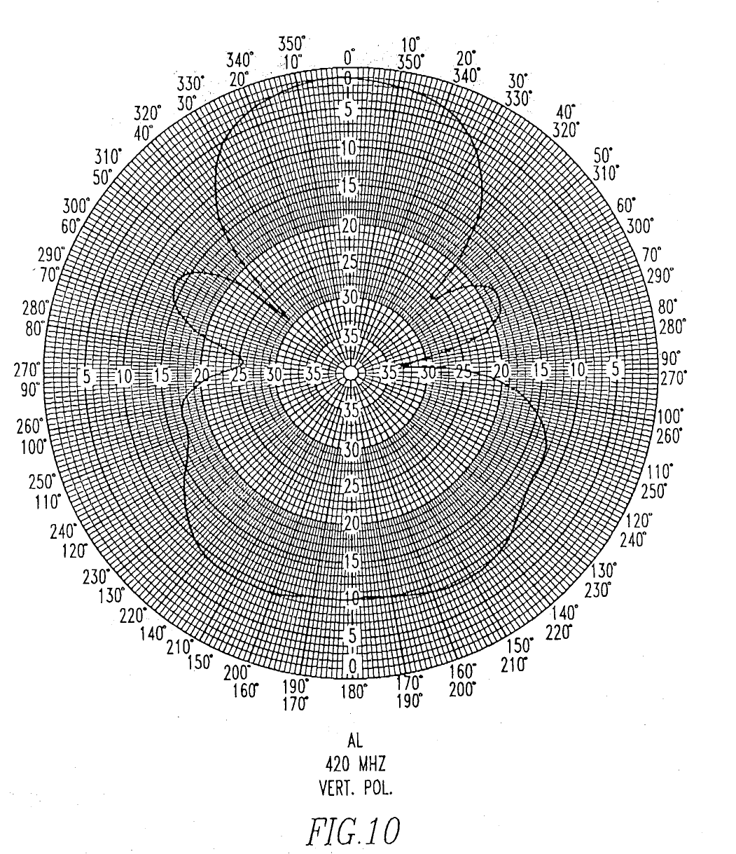

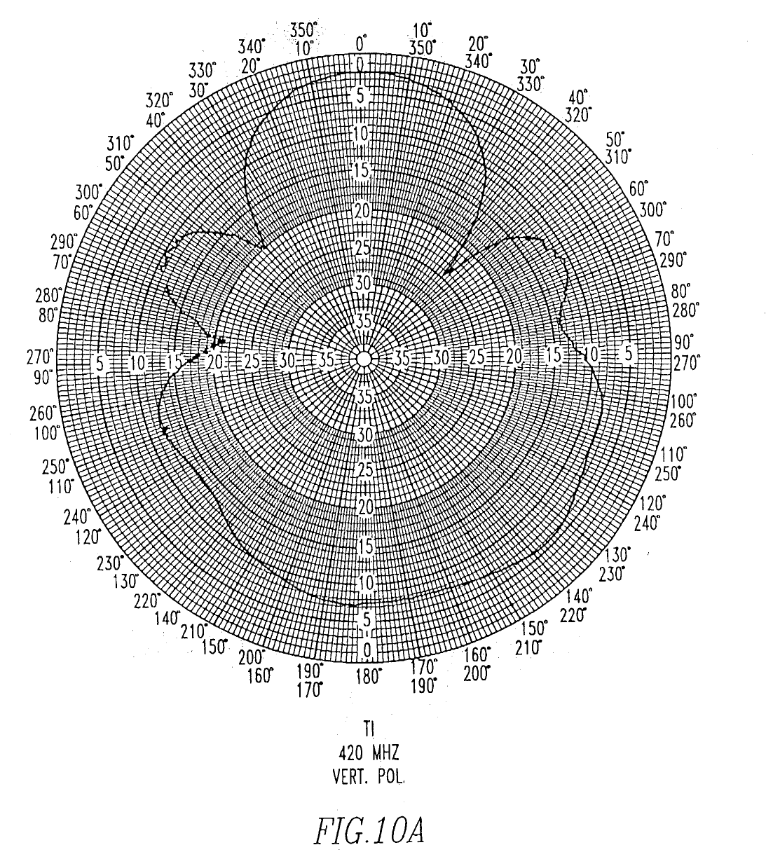

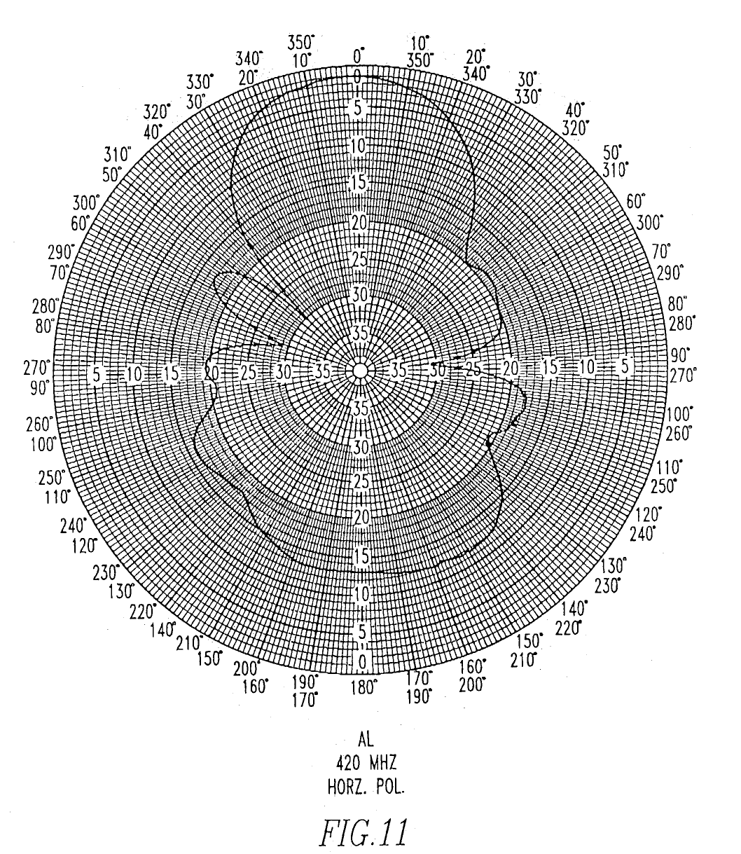

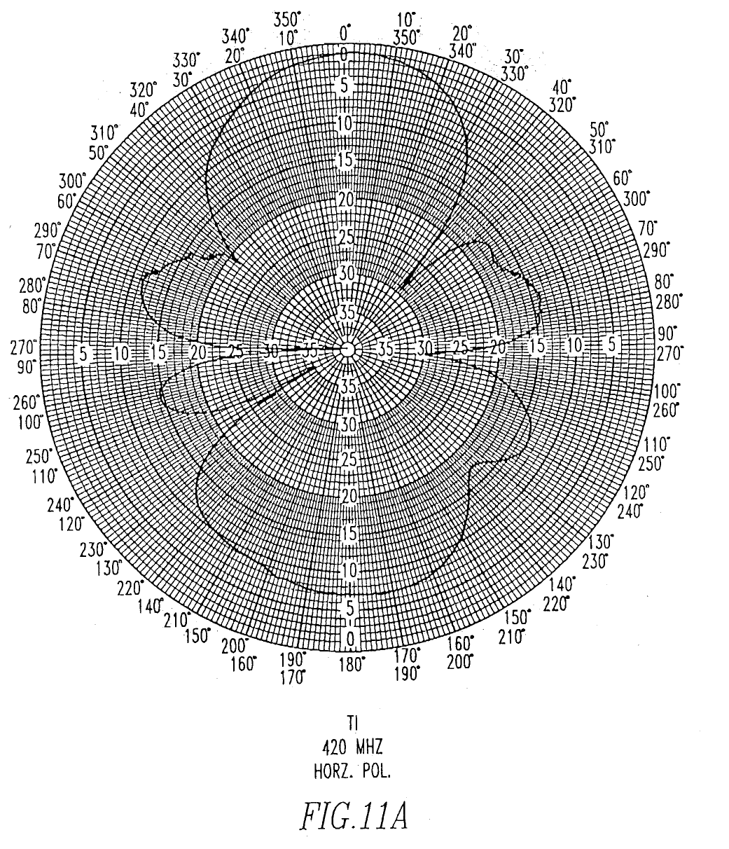

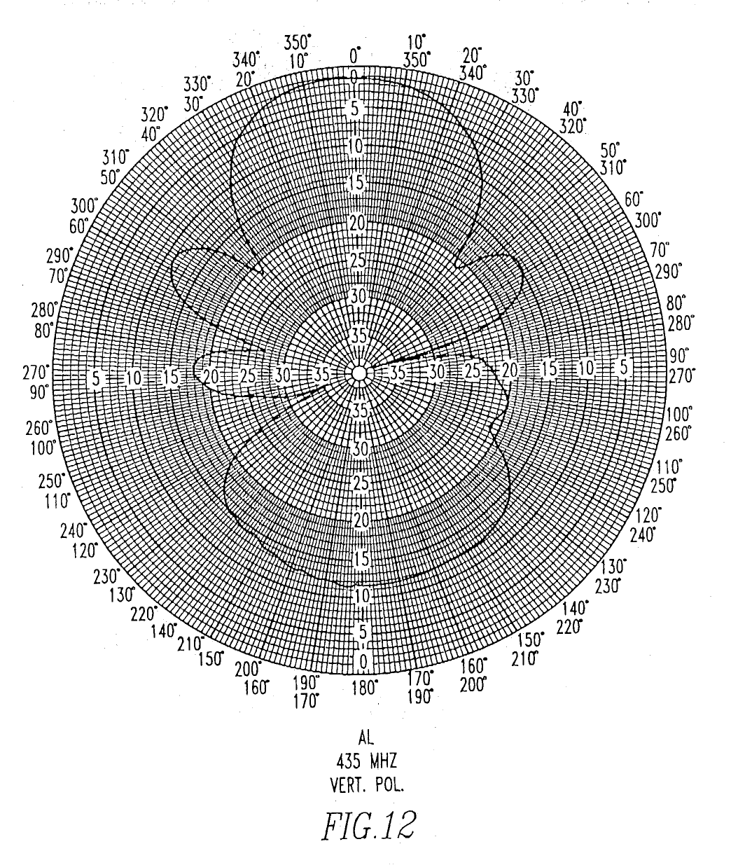

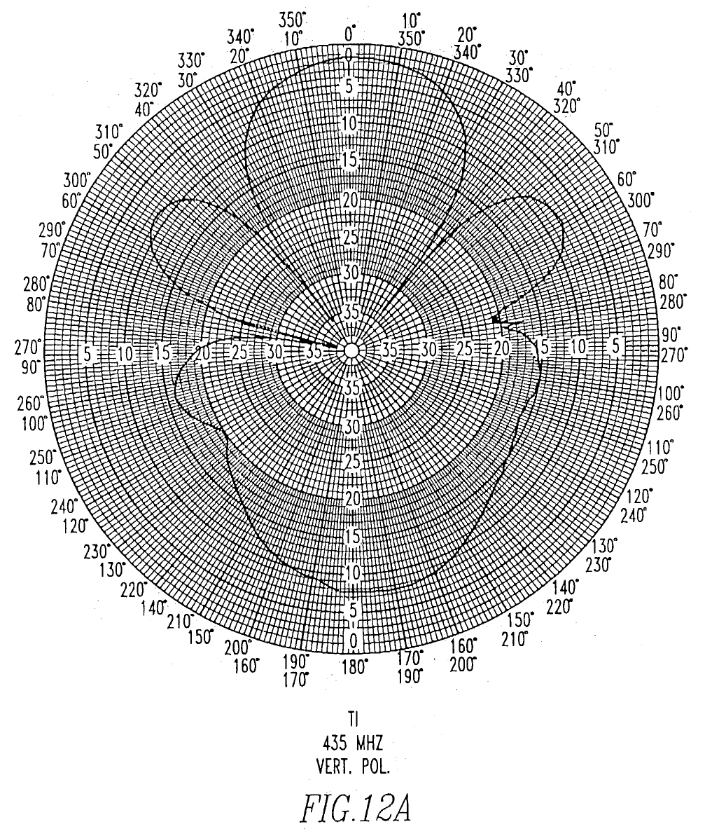

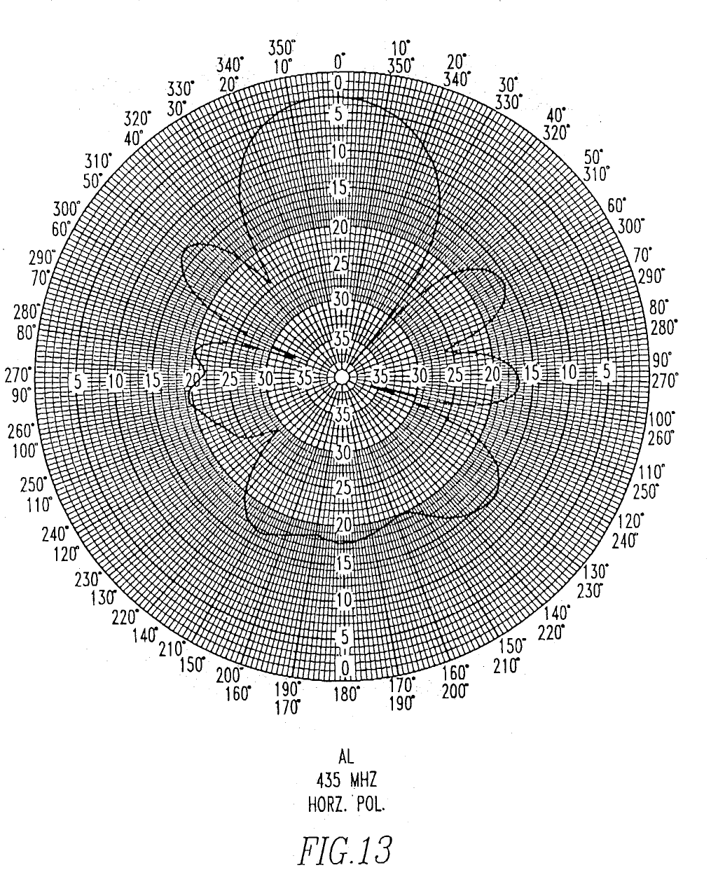

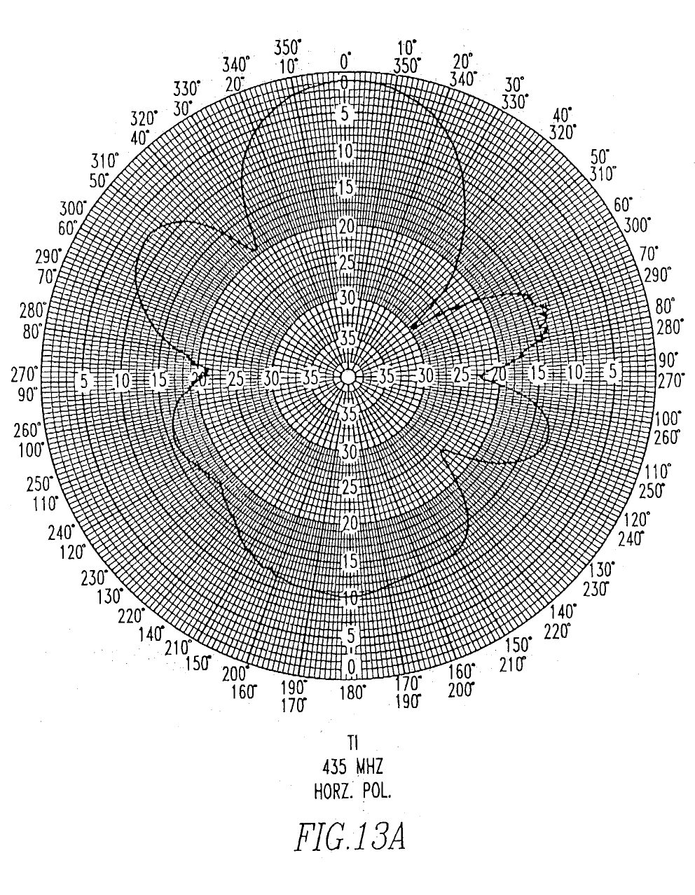

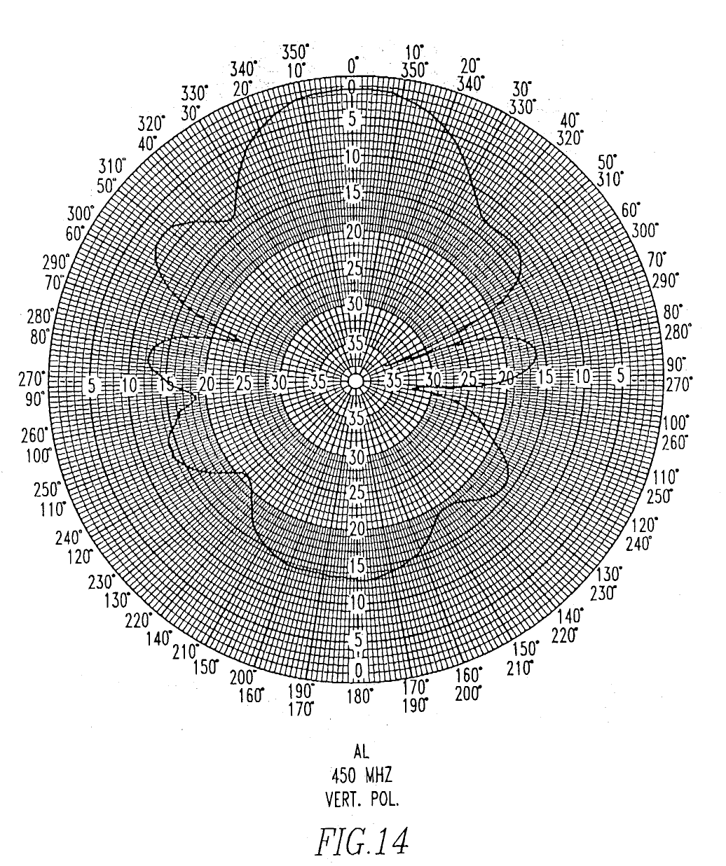

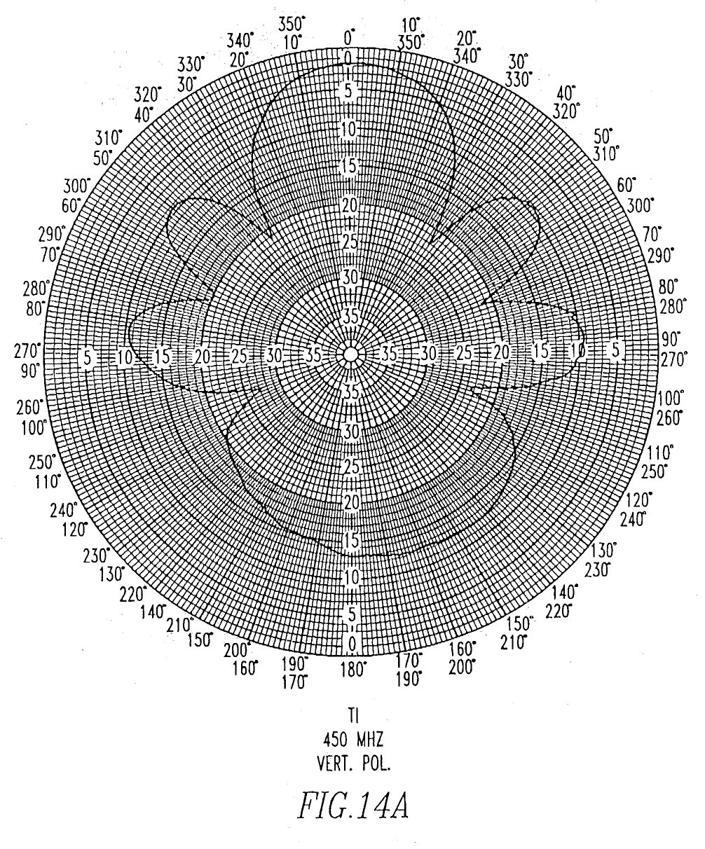

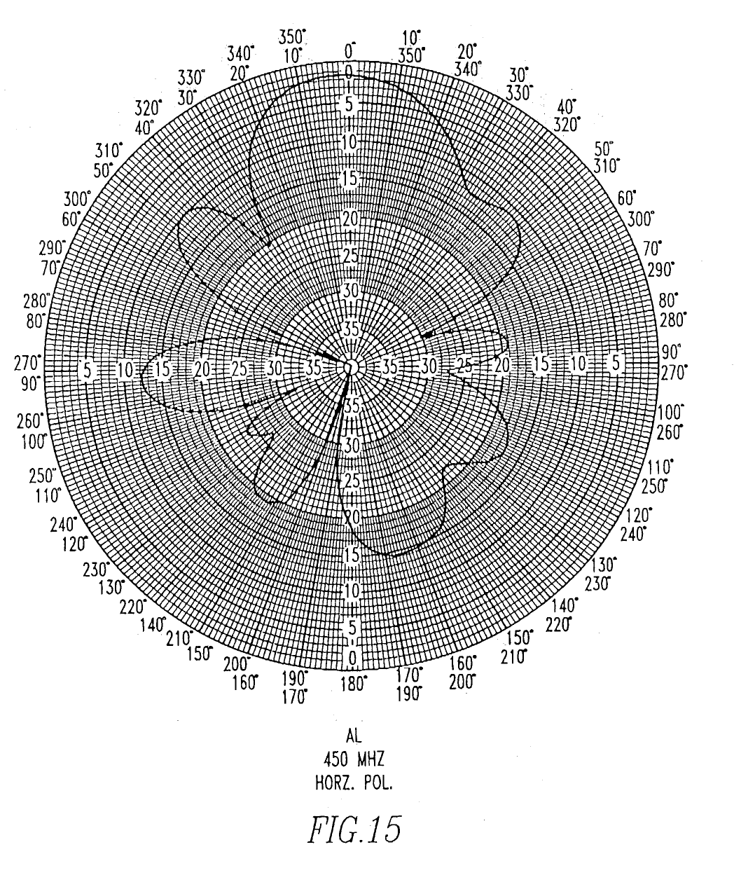

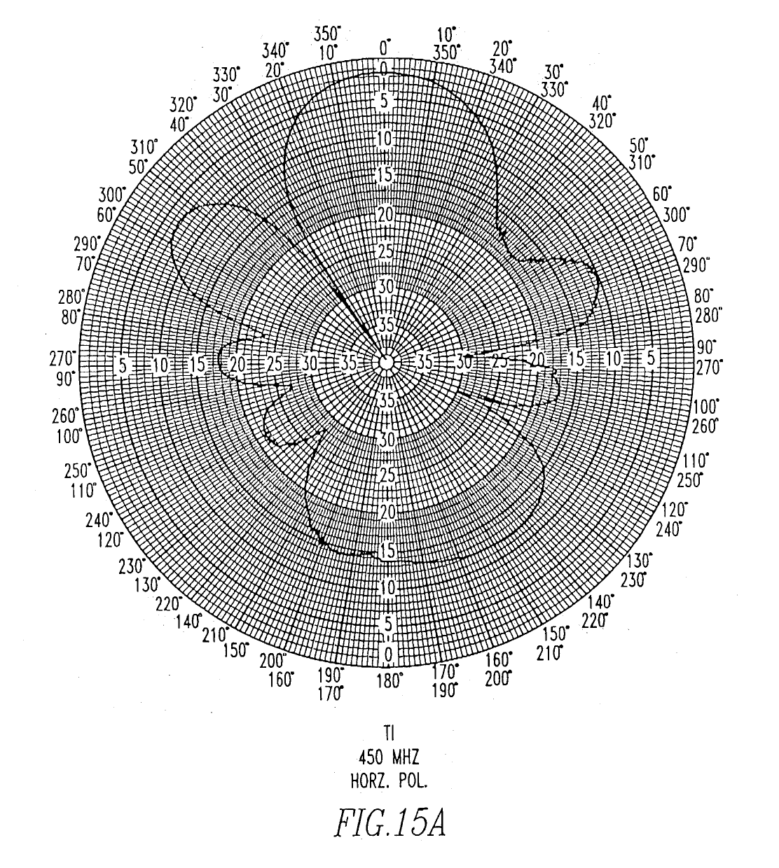

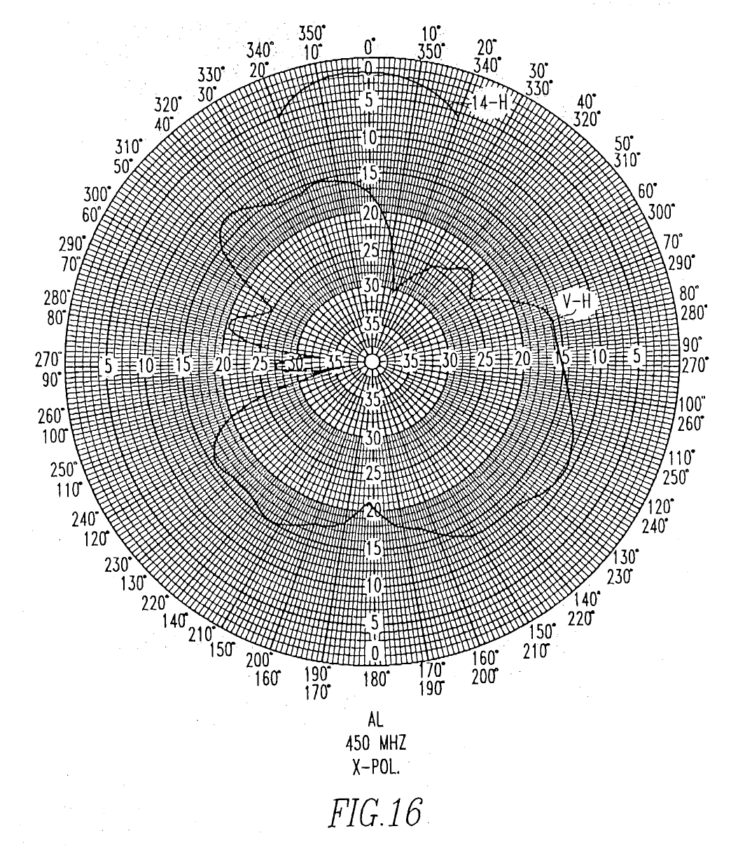

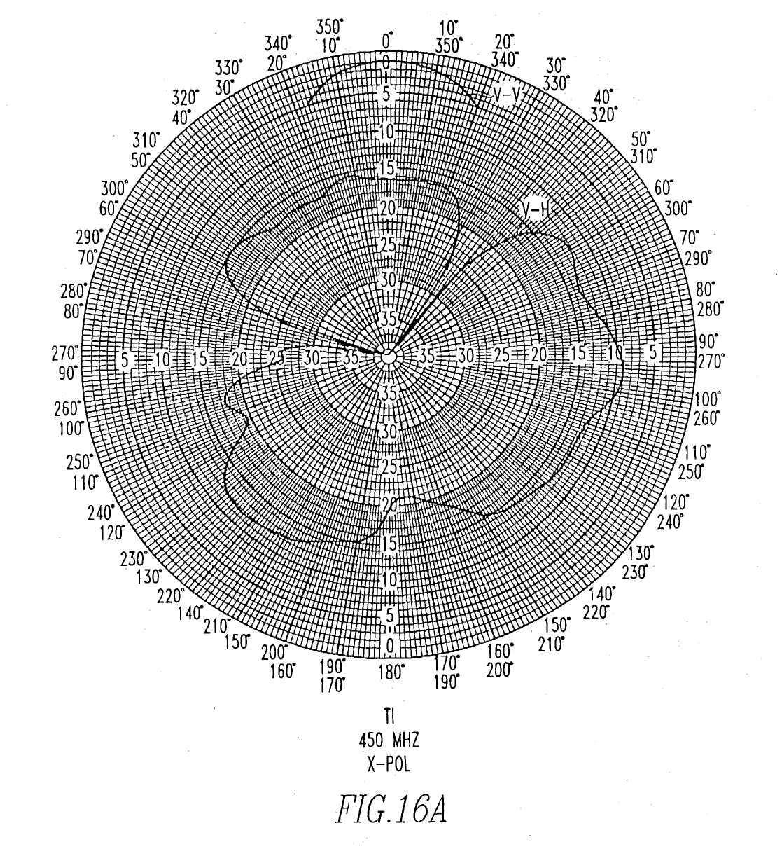

The results of these tests are shown in FIGS. 10-16A which depict the radiation patterns. For example, FIG. 10 shows the radiation pattern for the aluminum antenna at 420 MHz at vertical polarization, with FIG. 10A showing the results for the titanium antenna at 420 MHz vertical polarization. FIG. 11 shows the radiation pattern for the aluminum antenna at 420 MHz horizontal polarization and FIG. 11A shows the wave pattern of the titanium antenna at 420 MHz horizontal polarization. The results of the other tests are shown for the 435 MHz vertical and horizontal polarization for the aluminum and titanium antennas in FIGS. 12-13A; for the 450 MHz vertical and horizontal polarization in FIGS. 14-15A and at 450 MHz for the X polarization. These tests, the results of which are shown in FIGS. 10-19A, as well as the other tests, the results of which are shown in Tables 3-10 and in FIGS. 4-9, show that the titanium antenna, and in particular when formed almost entirely of Grade 2 Titanium, provides equal or greater than transmission/reception characteristics then the heretofore used aluminum alloy antennas. Thus in addition to providing for the increased transmission/reception capabilities, the titanium provides a considerably stronger, more durable and greater corrosion resistant antenna than that provided by aluminum antennas which will enable the antennas to be larger with less auxiliary supports due to the strength and rigidity of the titanium.

It will be appreciated that a titanium antenna has been described which has various surprising and unexpected advantages over aluminum type antennas.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

TABLE 1

| | LENGTH OF ELEMENT | DIA. OF ELEMENT |
|---|---|---|
| ELEMENT | IN INCHES | IN INCHES |
| 1 | 41.1024 | .750 |
| 2 | 38.4252 | .50 |
| 3 | 36.4566 | .250 |
| 4 | 36.1418 | .250 |
| 5 | 35.748 | .250 |
| 6 | 35.433 | .250 |
| 7 | 35.0394 | .250 |
| 8 | 34.7244 | .250 |
| 9 | 34.3306 | .250 |
| 10 | 34.0158 | .250 |

TABLE 2

| | LENGTH OF ELEMENT | DIAMETER OF ELEMENT |
|---|---|---|
| ELEMENT | IN INCHES | IN INCHES |
| 1 | 39.75 | .18 |
| 2 | 38.87 | .5 |
| 3 | 37.87 | .18 |
| 4 | 36.25 | .18 |
| 5 | 36.25 | .18 |
| 6 | 35.75 | .18 |
| 7 | 35.25 | .18 |
| 8 | 34.62 | .18 |
| 9 | 34.62 | .18 |
| 10 | 34.62 | .18 |
| 11 | 34.62 | .18 |
| 12 | 34.62 | .18 |
| 13 | 34.62 | .18 |

TABLE 3

| | |
|---|---|
| | STANDING |
| FREQUENCY IN Mhz | WAVE RATIO |

| 144-148 Mhz | Al | Ti |
|---|---|---|
| 144.00 | 1.5 | 1.1 |
| 144.25 | 1.3 | 1.3 |
| 144.50 | 1.2 | 1.4 |
| 144.75 | 1.1 | 1.5 |
| 145.00 | 1.2 | 1.6 |
| 145.25 | 1.4 | 1.6 |
| 145.50 | 1.5 | 1.6 |
| 145.75 | 1.6 | 1.5 |
| 146.00 | 1.7 | 1.4 |
| 146.25 | 1.7 | 1.3 |
| 146.50 | 1.6 | 1.2 |
| 146.75 | 1.6 | 1.1 |
| 147.00 | 1.5 | 1.1 |
| 147.25 | 1.5 | 1.1 |
| 147.50 | 1.5 | 1.2 |
| 147.75 | 1.5 | 1.2 |
| 148.00 | 1.6 | 1.1 |

TABLE 4

| | |
|---|---|
| | IMPEDENCE IN |
| FREQUENCY IN Mhz | Ohms |

| 144-148 Mhz | Al | Ti |
|---|---|---|
| 144.00 | 40 | 60 |
| 144.25 | 50 | 58 |
| 144.50 | 60 | 50 |
| 144.75 | 60 | 44 |
| 145.00 | 60 | 39 |
| 145.25 | 52 | 35 |
| 145.50 | 43 | 32 |
| 145.75 | 38 | 38 |
| 146.00 | 33 | 41 |
| 146.25 | 32 | 50 |
| 146.50 | 39 | 59 |
| 146.75 | 45 | 60 |
| 147.00 | 60 | 60 |
| 147.25 | 80 | 56 |
| 147.50 | 83 | 50 |
| 147.75 | 85 | 49 |
| 148.00 | 80 | 49 |

TABLE 5

| | |
|---|---|
| | RESISTANCE IN |
| FREQUENCY IN Mhz | Ohms |

| 144-148 Mhz | Al | Ti |
|---|---|---|
| 144.00 | 35 | 56 |
| 144.25 | 43 | 52 |
| 144.50 | 53 | 44 |
| 144.75 | 59 | 37 |
| 145.00 | 55 | 32 |
| 145.25 | 45 | 30 |
| 145.50 | 37 | 30 |
| 145.75 | 32 | 33 |
| 146.00 | 29 | 37 |
| 146.25 | 29 | 44 |
| 146.50 | 31 | 52 |
| 146.75 | 37 | 57 |
| 147.00 | 49 | 56 |
| 147.25 | 64 | 50 |
| 147.50 | 78 | 45 |
| 147.75 | 76 | 43 |
| 148.00 | 61 | 43 |

TABLE 6

| | |
|---|---|
| | REACTANCE IN |
| FREQUENCY IN Mhz | Ohms |

| 144-148 Mhz | Al | Ti |
|---|---|---|
| 144.00 | 8 | 2 |
| 144.25 | 11 | 13 |
| 144.50 | 8 | 16 |
| 144.75 | 0 | 14 |
| 145.00 | 10 | 10 |
| 145.25 | 15 | 5 |
| 145.50 | 13 | 0 |
| 145.75 | 8 | 5 |
| 146.00 | 0 | 10 |
| 146.25 | 0 | 12 |
| 146.50 | 9 | 9 |
| 146.75 | 17 | 0 |
| 147.00 | 22 | 2 |
| 147.25 | 19 | 8 |
| 147.50 | 0 | 8 |
| 147.75 | 11 | 5 |
| 148.00 | 27 | 0 |

TABLE 7

| | |
|---|---|
| | CAPACITANCE IN |
| FREQUENCY IN Mhz | PincoFarads |

| 144-148 Mhz | Al | Ti |
|---|---|---|
| 144.00 | 142 | 0 |
| 144.25 | 100 | 83 |
| 144.50 | 133 | 66 |
| 144.75 | 0 | 73 |
| 145.00 | 107 | 101 |
| 145.25 | 67 | 0 |
| 145.50 | 72 | 0 |
| 145.75 | 104 | 0 |
| 146.00 | 0 | 108 |
| 146.25 | 0 | 88 |
| 146.50 | 141 | 114 |
| 146.75 | 67 | 0 |
| 147.00 | 50 | 0 |
| 147.25 | 50 | 125 |
| 147.50 | 0 | 129 |
| 147.75 | 90 | 0 |
| 148.00 | 42 | 0 |

TABLE 8

| | |
|---|---|
| | INDUCTANCE IN |
| FREQUENCY IN Mhz | MicroHenrys |

| 144-148 Mhz | Al | Ti |
|---|---|---|
| 144.00 | 0.008 | 0.000 |
| 144.25 | 0.012 | 0.014 |
| 144.50 | 0.009 | 0.018 |
| 144.75 | 0.000 | 0.016 |
| 145.00 | 0.011 | 0.011 |
| 145.25 | 0.017 | 0.000 |
| 145.50 | 0.016 | 0.000 |
| 145.75 | 0.011 | 0.000 |
| 146.00 | 0.000 | 0.000 |
| 146.25 | 0.000 | 0.013 |
| 146.50 | 0.008 | 0.000 |
| 146.75 | 0.017 | 0.000 |
| 147.00 | 0.023 | 0.000 |
| 147.25 | 0.023 | 0.009 |
| 147.50 | 0.000 | 0.008 |
| 147.75 | 0.000 | 0.000 |
| 148.00 | 0.027 | 0.000 |

TABLE 9

| | | | | |
|---|---|---|---|---|
| | | | | IMP OHM |
| SWR | FREQUENCY | Al | Ti | CULMP TI |

| | | | | |
|---|---|---|---|---|
| 144.00 | 1.5 | 1.1 | 40 | 60 |
| 144.25 | 1.3 | 1.3 | 40 | 58 |
| 144.50 | 1.2 | 1.4 | 60 | 50 |
| 144.75 | 1.1 | 1.5 | 60 | 44 |
| 145.00 | 1.2 | 1.6 | 60 | 39 |
| 145.25 | 1.4 | 1.6 | 52 | 35 |
| 145.50 | 1.5 | 1.6 | 43 | 32 |
| 145.75 | 1.6 | 1.5 | 38 | 38 |
| 146.00 | 1.7 | 1.4 | 33 | 41 |
| 146.25 | 1.7 | 1.3 | 32 | 50 |
| 146.50 | 1.6 | 1.2 | 39 | 59 |
| 146.75 | 1.6 | 1.1 | 45 | 60 |
| 147.00 | 1.5 | 1.1 | 60 | 60 |
| 147.25 | 1.5 | 1.1 | 80 | 56 |
| 147.50 | 1.5 | 1.2 | 83 | 50 |
| 147.75 | 1.5 | 1.2 | 85 | 49 |
| 148.00 | 1.6 | 1.1 | 80 | 49 |

BEAM WIDTH

| | |
|---|---|
| 1.7 mile | 70 deg 5 watt 1.7 miles |
| Al | 30 deg 5 watt 5.8 miles |
| Ti | 50 deg 5 watt 3.8 miles |

| | | |
|---|---|---|
| Signal StrNear field 500 YDS 500 mw | −52 db | −53 db |
| Signal StrNear field 1 mile 500 mw | −84 db | −92 db |
| Signal Str 1.7 mile 500 mw | −98 db | −99 db |
| Signal Str 3.1 mile 5 w | −77 db | −73 db |
| Signal Str 3.8 mile 5 w | −79 db | −78 db |
| Signal Str 5.2 mile 5 w | −96 db | −96 db |
| Front/Back 5 watt 5.2 miles | −81/−90 | −78/−90 |

TABLE 10

| Rs Al | Xs Al | Rs Ti | Xs Ti | Al | Ti | IND | Al | IND | Ti |
|---|---|---|---|---|---|---|---|---|---|
| 35 | 8 | 56 | 2 | 142 | 200 | | 0.008 | < > | |
| 43 | 11 | 52 | 13 | 100 | 83 | | 0.012 | | 0.014 |
| 53 | 8 | 44 | 16 | 133 | 66 | | 0.009 | | 0.018 |
| 59 | 0 | 37 | 14 | 200 | 73 | < > | | | 0.016 |
| 55 | 10 | 32 | 10 | 107 | 101 | | 0.011 | | 0.011 |
| 45 | 15 | 30 | 5 | 67 | 200 | | 0.017 | < > | |
| 37 | 13 | 30 | 0 | 72 | 200 | | 0.016 | < > | |
| 32 | 8 | 33 | 5 | 104 | 200 | | 0.011 | < > | |
| 29 | 0 | 37 | 10 | 200 | 108 | < > | | | 0.010 |
| 29 | 0 | 44 | 12 | 200 | 88 | < > | | | 0.013 |
| 31 | 9 | 52 | 9 | 141 | 114 | | 0.008 | | 0.010 |
| 37 | 17 | 57 | 0 | 67 | 200 | | 0.017 | < > | |
| 49 | 22 | 56 | 2 | 50 | 200 | | 0.023 | < > | |
| 64 | 19 | 50 | 8 | 50 | 125 | | 0.023 | | 0.009 |
| 78 | 0 | 45 | 8 | 200 | 129 | < > | | | 0.008 |
| 76 | 11 | 42 | 5 | 90 | 200 | | 0.010 | < > | |
| 61 | 27 | 43 | 0 | 42 | 200 | | 0.027 | < > | |

1. An antenna for radiating and receiving magnetic radiation consisting essentially of titanium metal.

2. The antenna of claim 1 which has a longitudinal boom and a plurality of spaced elements extending transversely from said boom.

3. The antenna of claim 1 which has standing wave ratio characteristics which are superior to a structurally and dimensionally similar aluminum or aluminum alloy antenna.

4. The antenna of claim 3 wherein said superior standing wave ratio characteristics are in a frequency range of from about 145.00 MHz to about 145.50 MHz.

5. The antenna of claim 1 which has impedance which is greater than a structurally and dimensionally similar aluminum or aluminum alloy antenna.

6. The antenna of claim 5 wherein said impedance is greater than the aluminum antenna in a frequency of from about 144.00 MHz to about 144.25 MHz and from about 145.70 MHz to about 146.50 MHz.

7. The antenna of claim 1 which has resistance which is greater than a structurally and dimensionally similar aluminum or aluminum alloy antenna.

8. The antenna of claim 7 wherein resistance is greater than the aluminum or aluminum alloy antenna at a frequency of from about 144.00 MHz to about 144.25 MHz to about 144.25 MHz and from aobut 145.75 MHz to about 147.00 MHz.

9. The antenna of claim 1 which has reactance which is greater than a structurally and dimensionally similar aluminum or aluminum alloy antenna.

10. The antenna of claim 9 wherein reactance is greater than the aluminum or aluminum alloy antenna at a frequency of from about 144.25 to about 144.75 MHz 146.00 to about 146.25 MHz.

11. The antenna of claim 1 which has capacitance which is greater than a structurally and dimensionally similar aluminum or aluminum alloy antenna.

12. The antenna of claim 11 wherein capacitance is greater than the aluminum or aluminum alloy antenna at a frequency from about 146.00 to about 146.25 MHz and from about 147.25 to about 147.50 MHz.

13. The antenna of claim 1 which has a inductance which is greater than a structurally and dimensionally similar aluminum or aluminum alloy antenna.

14. The antenna of claim 13 wherein inductance is greater than the aluminum or aluminum alloy antenna at a frequency of from about 144.25 to about 144.75 MHz.

15. The antenna of claim 1 wherein the antenna consists essentially of a Grade 2 Titanium metal.

16. The antenna of claim 3 wherein the antenna consists essentially of Grade 2 Titanium metal and the second antenna consists essentially of an aluminum alloy.

17. A YAGI antenna having a boom; and a driver element, a reflector element and a plurality of dipole elements mounted on the boom and extending generally perpendicular thereto, wherein said boom, driver elements, reflector element and dipole elements are formed substantially of Grade 2 or Grade 4 Titanium.

18. The antenna of claim 17 wherein the Grade 2 Titanium has a minimum tensile strength of 50 ksi and a yield of between 40 ksi and 65 ksi at 20% elongation.

19. The antenna of claim 17 wherein the Grade 4 Titanium has a minimum tensile strength of 80 ksi and a yield of between 70 ksi and 95 ksi at 15% elongation.
